(19) United States
(12) Patent Application Publication
(10) Pub. No.: US 2026/0068006 A1
(43) Pub. Date: Mar. 5, 2026

(54) PLATE FOR COOKING APPARATUS AND COOKING APPARATUS INCLUDING THE SAME

(71) Applicant: SAMSUNG ELECTRONICS CO., LTD., Suwon-si (KR)

(72) Inventors: Jooyong YOON, Suwon-si (KR); Jiyoung SONG, Suwon-si (KR)

(73) Assignee: SAMSUNG ELECTRONICS CO., LTD., Suwon-si (KR)

(21) Appl. No.: 19/305,068

(22) Filed: Aug. 20, 2025

Related U.S. Application Data
(63) Continuation of application No. PCT/KR2025/011417, filed on Jul. 31, 2025.

(30) Foreign Application Priority Data
Sep. 5, 2024 (KR) 10-2024-0121155

(51) Int. Cl. H05B 6/12

(52) U.S. Cl. CPC H05B 6/12

(57) ABSTRACT

The present disclosure relates to a plate for cooking apparatuses including a glass ceramic substrate, and a hard coating layer on the glass ceramic substrate, a hard coating layer including a plurality of calcium (Ca) agglomerate structures in at least one area, wherein in the hard coating layer, in a cross-section perpendicular to an upper surface of the glass ceramic substrate, as the Ca agglomerate structures are closer to the upper surface of the glass ceramic substrate a ratio of the Ca agglomerate structures per unit volume increases.

### CROSS-REFERENCE TO RELATED APPLICATIONS

This application is a continuation application of International Application No. PCT/KR2025/011417 filed Jul. 31, 2025, and claims foreign priority to Korean Application No. 10-2024-0121155, filed Sep. 5, 2024, and which are incorporated herein by reference in their entireties.

### TECHNICAL FIELD

The present disclosure relates to a plate for cooking apparatuses and a cooking apparatus including the same, and more particularly, to a cooking apparatus used to heat food by generating heat and a plate for cooking apparatuses applied thereto.

### BACKGROUND ART

Induction devices (induction heating devices) have been used to heat food by generating heat). Particularly, cooktops (or hobs) are used as cooking apparatuses to heat food by using an induction device.

In general, ceramic glass having excellent heat resistance is used in the top of a cooktop. Ceramic glass is highly resistant to fractures by thermal shock and has excellent mechanical strength and thermal conductivity. However, ceramic glass, in the case of being applied to cooktops, requires particular properties such as mechanical strength and heat resistance because the cooktops are continuously exposed to high-temperature environments, physical impacts, and the like, and therefore research is conducted into methods of using various coating layers to improve the properties such as mechanical strength and heat resistance.

### DISCLOSURE

### Technical Problem

Provided are a plate for cooking apparatuses having improved scratch resistance and realized to have various colors, and a cooking apparatus including the same, to improve aesthetic and functional properties. Particularly, in the case of manufacturing a white cooking apparatus, a plate for cooking apparatuses realizing clear white color and having excellent mechanical strength is provided.

However, the technical problems to be solved by the present disclosure are not limited to the aforementioned problems, and any other technical problems not mentioned herein will be clearly understood from the following description by those skilled in the art to which the present disclosure pertains.

### Technical Solution

In accordance with an aspect of the present disclosure, a plate for cooking apparatuses includes a glass ceramic substrate, and a hard coating layer on the glass ceramic substrate, the hard coating layer including a plurality of calcium (Ca) agglomerate structures in at least one area, wherein in the hard coating layer, in a cross-section perpendicular to an upper surface of the glass ceramic substrate, as the Ca agglomerate structures are closer to the upper surface of the glass ceramic substrate, a ratio of the Ca agglomerate structures per unit volume increases.

In addition, a plate for cooking apparatuses according to an embodiment of the present disclosure includes a glass ceramic substrate having a β-spodumene crystalline phase, a hard coating layer disposed on the glass ceramic substrate and including a plurality of Ca agglomerate structures distributed in at least an area adjacent to the glass ceramic substrate, and an encapsulation layer disposed on the hard coating layer to cover the hard coating layer, wherein an L* value in the CIE Lab* color space is at least 80 but not more than 100.

In addition, a cooking apparatus according to an embodiment of the present disclosure includes a plate for cooking apparatuses on which a cooking container is placed and a main body disposed below the plate for cooking apparatuses and including a plurality of induction heating coils configured to generate a magnetic field, wherein the plate for cooking apparatuses includes a glass ceramic substrate, and a colorless transparent hard coating layer disposed on the glass ceramic substrate, wherein the hard coating layer includes a plurality of Ca agglomerate structures each having a diameter of at least 40 nm but not more than 60 nm.

### Advantageous Effects

According to an embodiment of the present disclosure, a plate for cooking apparatuses having various colors may be provided. Particularly, in the case of implementing a plate for white cooking apparatuses, excellent scratch resistance may be obtained even if a colorless transparent hard coating layer is applied thereto.

### DESCRIPTION OF DRAWINGS

FIG. 1 is an overall perspective view of a cooking apparatus according to an embodiment of the present disclosure.

FIG. 2 is an exploded perspective view of the cooking apparatus illustrated in FIG. 1.

FIG. 3 is a cross-sectional view taken along line A-A′ shown in FIG. 2.

FIG. 4 is an enlarged cross-sectional view of area B shown in FIG. 3.

FIG. 5A shows distribution of calcium in area B of a conventional top plate.

FIG. 5B shows distribution of calcium in area B of a top plate according to an embodiment of the present disclosure.

FIG. 6A is a view showing a scratch resistance test of a top plate.

FIG. 6B is a photograph showing the surface of the top plate before the scratch resistance test.

FIG. 7A is a photograph showing an example of the surface of the top plate after completion of the scratch resistance test.

FIGS. 7B and 7C are photographs showing comparative examples of the surface of the top plate after completion of the scratch resistance test.

FIG. 8A is a photograph of a surface of a top plate according to an example after completion of a scratch resistance test.

FIG. 8B is a photograph of a surface of a top plate according to a comparative example after completion of a scratch resistance test.

FIG. 9 is a cross-sectional view taken along line A-A′ of a top plate according to another embodiment of the present disclosure.

FIG. 10 is a cross-sectional view taken along line A-A′ of a top plate according to another embodiment of the present disclosure.

FIG. 11A is a table showing constituent elements of a glass ceramic substrate according to an embodiment of the present disclosure and a composition ratio thereof.

FIG. 11B is a table showing constituent elements of a hard coating layer according to an embodiment of the present disclosure and a composition ratio thereof.

FIG. 11C is a table showing constituent elements of an encapsulation layer according to an embodiment of the present disclosure and a composition ratio thereof.

FIG. 12 is a table showing nanoindentation measurements of a top plate according to an embodiment of the present disclosure.

FIG. 13 is a photograph of a Mohs hardness tester for measuring Mohs hardness.

### MODE OF INVENTION

Various embodiments of the present disclosure and terms used herein are not intended to limit technical features disclosed herein to particular modes of practice, and it is to be appreciated that all changes, equivalents, and substitutes of the embodiments are encompassed in the present disclosure.

Regarding the description of the drawings, like reference numerals may be used for like or related elements throughout the drawings.

The singular form of a noun corresponding to an item may include one or more items unless the context states otherwise.

Throughout the specification, “A or B”, “at least one of A and B”, “at least one of A or B”, “A, B or C”, “at least one of A, B and C”, and “at least one or A, B, or C” may each include any one or all the possible combinations of A, B and C.

The term “and/or” is interpreted to include a combination or any of associated elements.

Terms such as “first” or “second” are used to distinguish one component from other components and, therefore, the components are not limited by the terms in any other aspect (e.g., importance or order).

Also, the terms used throughout the specification ‘front’, ‘rear’, ‘top’, ‘bottom’, ‘side’, ‘left’, ‘right’, ‘upper’, ‘lower’, and the like are defined based on the drawings and the shape and position of each element are not limited by these terms.

In addition, the terms such as “including” or “having” are intended to indicate the existence of features, numbers, processes, operations, components, parts, or combinations thereof disclosed in the specification, and are not intended to preclude the possibility that one or more other features, numbers, processes, operations, components, parts, or combinations thereof may exist or may be added.

When an element is mentioned as being “connected to”, “coupled to”, “supported by”, or “contacting” another element, it includes not only a case that the elements are directly connected to, coupled to, supported by or contact each other but also a case that the elements are connected to, coupled to, supported by or contact each other through a third element.

When an element is mentioned as being located “on” another element, it implies not only that the element is in direct contact with the other element but also that a third element exists between the two elements.

Hereinafter, a plate for cooking apparatuses and a cooking apparatus including the same according to various embodiments will be described in detail.

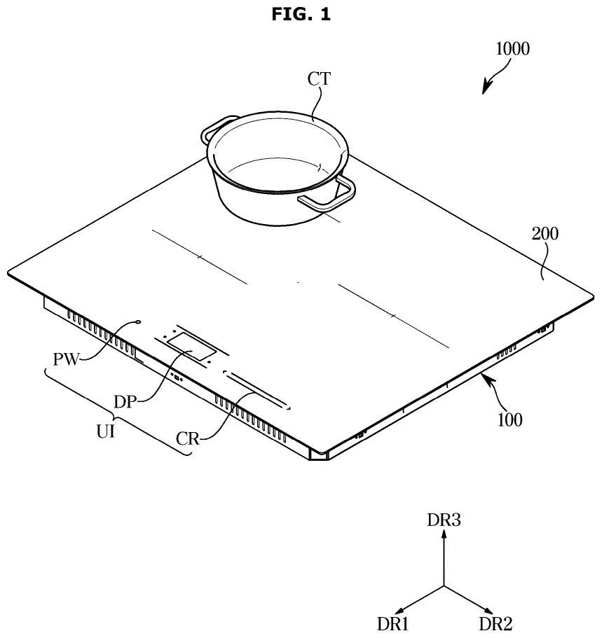

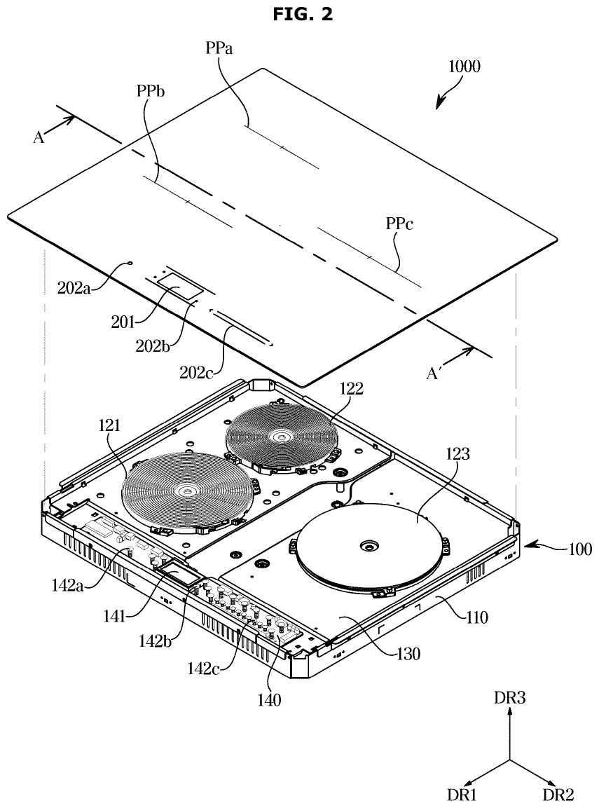

FIG. 1 is an overall perspective view of a cooking apparatus according to an embodiment of the present disclosure. FIG. 2 is an exploded perspective view of the cooking apparatus illustrated in FIG. 1.

Referring to FIGS. 1 and 2, a cooking apparatus 1000 according to an embodiment of the present disclosure may be an induction heating device (induction device) configured to heat and cook food by using the principle of induction heating. The cooking apparatus 1000 transfers heat to a cooking container CT placed on the cooking apparatus 1000 by using the induction heating principle. However, the principle of heating the cooking apparatus 1000 is not particularly limited in the present disclosure.

According to the embodiment, a user interface UI may be provided at one of areas defined on the upper surface of the cooking apparatus 1000. The user interface UI may include a power inputter PW, a display DP, and a controller CR. A user may input power by the power inputter PW and control the cooking apparatus 1000 by the controller CR. In addition, the user may check cooking information including a temperature of the cooking container CT, elapsed cooking time, and day/time.

The cooking apparatus 1000 includes a main body 100 and a plate 200 for cooking apparatuses (hereinafter, referred to as top plate). The main body 100 may be detachably coupled to the top plate 200 disposed on top of the main body 100.

The main body 100 includes a housing 110, a plurality of induction heating coils 121, 122, and 123, a coil mounting plate 130, an interface board 140, and a driving circuit board (not shown).

The housing 110 forms the exterior appearance of the cooking apparatus 1000. The housing 110 may accommodate components of the main body 100 in an internal space defined by the housing 110. In addition, the housing 110 may support the top plate 200 disposed on top of the housing 110. The housing 110 may have a box shape with an open top. In the embodiment, the housing 110 may have a rectangular shape with a shorter side, as an upper side, in a first direction DR1, and a longer side in a second direction DR2 perpendicular to the first direction DR1, but the specific shape of the housing 110 is not particularly limited in the present disclosure.

The induction heating coils 121, 122, and 123 are accommodated in the housing 110. Areas on which the induction heating coils 121, 122, and 123 are arranged define heating areas. That is, a user may heat food contained in a cooking container CT by induction heating by placing the cooking container CT on areas on the upper surface of the cooking apparatus 1000 corresponding to the areas in which the induction heating coils 121, 122, and 123 are arranged. The induction heating coils 121, 122, and 123 are wound in a substantially circular shape to form a magnetic field in the vertical direction DR3 upon a current supplied thereto. The induction heating coils 121, 122, and 123 may be electrically connected to a driving circuit board (not shown) to receive driving signals.

The induction heating coils 121, 122, and 123 may be mounted on the coil mounting plate 130. Guide holes for mounting the induction heating coils 121, 122, and 123 may be formed on the coil mounting plate 130.

Although a case of using the induction heating coils 121, 122, and 123 as heat sources is described in the embodiment, the present disclosure is not limited thereto. For example, according to another embodiment of the present disclosure, an induction heater by using an induction heating method other than the induction heating coils 121, 122, and 123 or a radiant heater using an electric resistance heating method may be used as the heat source.

The interface board 140 may be disposed in the housing 110 to correspond to the user interface UI of the cooking apparatus 1000. Specifically, the interface board 140 may include a display panel 141, a power input terminal 142a, and touch input terminals 142b and 142c. The display panel 141 is disposed at an area corresponding to the display DP. The power input terminal 142a is disposed at an area corresponding to the power inputter PW, and the touch input terminals 142b and 142c are disposed at an area corresponding to the controller CR. In the embodiment, the power input terminal 142a and the touch input terminals 142b and 142c may be touch electrodes configured to receive touch signals.

The driving circuit board (not shown) is disposed in the housing 110 to control driving of the induction heating coils 121, 122, and 123 and the interface board 140. In an embodiment of the present disclosure, the driving circuit board (not shown) may be disposed on the rear surface of the coil mounting plate 130. However, the position of the driving circuit board (not shown) is not particularly limited in the present disclosure.

The top plate 200 is disposed on top of the main body 100. A display window 201 and a plurality of guide marks PPa, PPb, PPc, 202a, 202b, and 202c may be formed on the upper surface of the top plate 200

The display window 201 is provided to expose the display panel 141 to the outside, and an area of the top plate 200 where the display window 201 is formed may have an optical transmittance.

The plurality of guide marks PPa, PPb, PPc, 202a, 202b, and 202c may be printed on the upper surface of the top plate by glass printing. For example, the plurality of guide marks PPa, PPb, PPc, 202a, 202b, and 202c may be formed based on the principle that a glass ink permeates into the top plate 200 after a pattern is printed on the top plate 200 using the glass ink. In the present disclosure, the material used for the glass printing may be any material generally known as glass ink without particular limitation.

The plurality of guide marks PPa, PPb, PPc, 202a, 202b, and 202c may include heating area indicating marks PPa, PPb, and PPc configured to indicate heating areas, a power indicating mark 202a configured to indicate a power PW, and controller marks 202b and 202c configured to indicate the controller CR. In the embodiment, the top plate 200 may have a property transmitting an external touch signal to the power input terminal 142a and the touch input terminals 142b and 142c.

Although not shown in the drawings, the cooking apparatus 1000 according to an embodiment of the present disclosure may further include components other than the main body 100 and the top plate 200. For example, the other components may be a ventilation device including a filter, a fan, and the like.

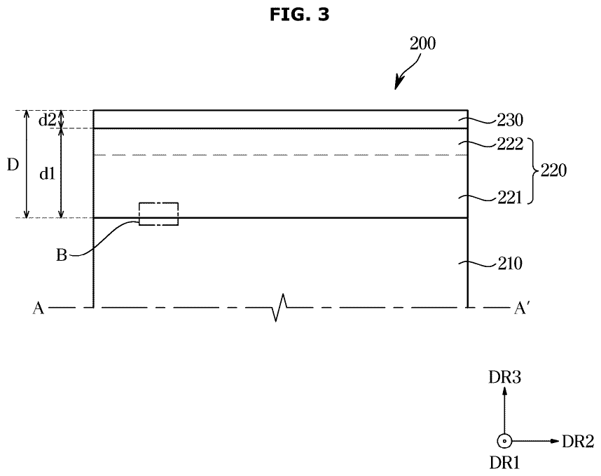

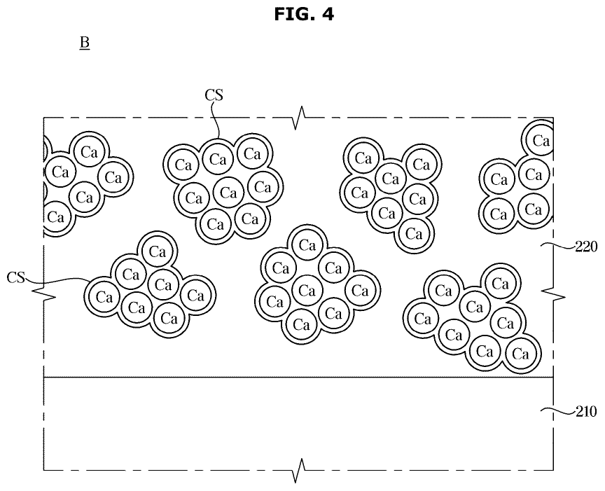

FIG. 3 is a cross-sectional view taken along line A-A′ shown in FIG. 2. FIG. 4 is an enlarged cross-sectional view of area B shown in FIG. 3.

Referring to FIGS. 3 and 4, the top plate 200 includes a glass ceramic substrate 210, a hard coating layer 220, and an encapsulation layer 230. The glass ceramic substrate 210, the hard coating layer 220, and the encapsulation layer 230 are stacked in the vertical direction DR3.

The glass ceramic substrate 210 may include a lithium aluminosilicate crystalline glass including Li₂O, Al₂O₃, and SiO₂ as basic components to obtain heat resistance. In the embodiment, the color of the glass ceramic substrate 210 may vary according to the content of elements contained in the glass ceramic substrate 210. More specifically, the glass ceramic substrate 210 may further include at least one element selected from the group consisting of V, Mg, P, Fe, Ti, Cr, and Zr according to a desired color, but the embodiment is not limited thereto. For example, the P content and the Zr content of the glass ceramic substrate 210 may be increased to obtain white color, and the V content of the glass ceramic substrate 210 may be increased to obtain black color.

The glass ceramic substrate 210 according to the embodiment may have different crystalline phases depending on crystallization temperature and the color of the glass ceramic substrate 210 may vary according to the crystalline phase. That is, the glass ceramic substrate 210 may include at least one crystalline phase selected from β-quartz, β-spodumene, and β-eucryptite. For example, in the case of including the β-quartz crystalline phase, the glass ceramic substrate 210 may realize a transparent color, and in the case of including the β-spodumene crystalline phase, the glass ceramic substrate 210 may realize a white color.

In a preferred embodiment of the present disclosure, the glass ceramic substrate 210 may have a transparent color, and in a more preferred embodiment, the glass ceramic substrate 210 may have a white color. In the case of having a white color, the glass ceramic substrate 210 may include the β-spodumene crystalline phase and an L* value of at least 80 but not more than 100 in the CIE Lab* color space.

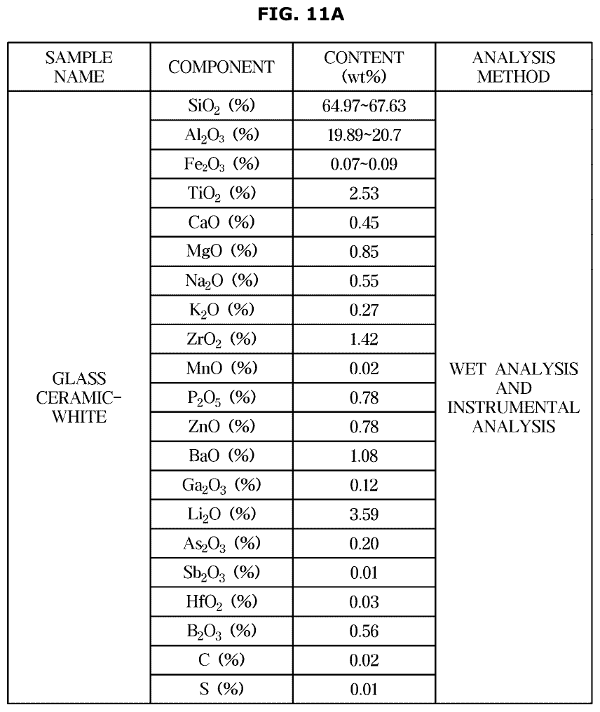

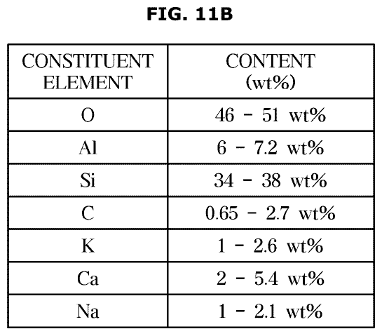

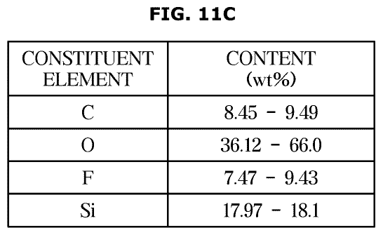

In FIG. 11A, a table shows constituent elements of a glass ceramic substrate having a white color and a composition ratio thereof.

In the embodiment, the glass ceramic substrate 210 may have a Mohs hardness of at least 4.5 but not more than 5.5 and a nanoindentation hardness of at least 6 Gpa but not more than 7 GPa.

In addition, the glass ceramic substrate 210 according to the embodiment may be about 4 mm in thickness. However, the thickness of the glass ceramic substrate 210 of the present disclosure is not particularly limited.

The hard coating layer 220 and the encapsulation layer 230 are disposed on the glass ceramic substrate 210. The hard coating layer 220 and the encapsulation layer 230 define a reinforced stack structure (not shown). The hard coating layer 220 and the encapsulation layer 230 may have the same coefficient of thermal expansion as that of the glass ceramic substrate 210. Therefore, delamination among the glass ceramic substrate 210, the hard coating layer 220, and the encapsulation layer 230 or cracking therein may be prevented even by a temperature change caused by heat transferred from the main body 100. For example, the coefficient of thermal expansion may be 1×10⁻⁶ K⁻¹ or less in a temperature range of 20° C. to 650° C.

In the embodiment, the reinforced stack structure (not shown) may be a colorless transparent material. That is, each of the hard coating layer 220 and the encapsulation layer 230 may have an optical transmittance of 70% or more. In addition, a color difference (ΔE) between the hard coating layer 220 and the glass ceramic substrate 210 and a color difference (ΔE) between the encapsulation layer 230 and the glass ceramic substrate 210 may be at least 0 but not more than 2. Therefore, in the case where the glass ceramic substrate 210 has a white color, the top plate 200 may have an L* value of at least 80 but not more than 100 in the CIE Lab* color space. That is, according to the present disclosure, the top plate 200 having a clear white color may be provided.

In addition, in the case where the top plate 200 has a color other than white, the color of the hard coating layer 220 may be exposed through the reinforced stack structure (not shown) with high optical transmittance, and thus the top plate 200 having various colors may be realized.

In addition, although not shown in the drawings, the hard coating layer 220 according to another embodiment of the present disclosure may further include an inorganic pigment in addition to the mixture providing the properties of the hard coating layer 220. In this case, the hard coating layer 220 may have a certain color, and the color of the hard coating layer 220 may become more vivid due to the white glass ceramic substrate 210 disposed below the hard coating layer 220.

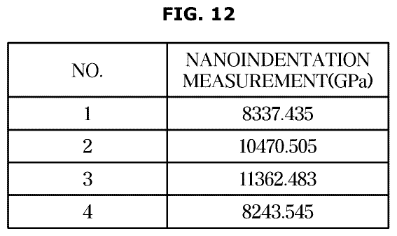

In the embodiment, the reinforced stack structure (not shown) may have a Mohs hardness of at least 6.5 but not more than 7.5. In addition, the reinforced stack structure (not shown) may have a nanoindentation hardness of at least 8 GPa but not more than 12 GPa. In FIG. 12, a table shows nanoindentation measurements of a top plate according to an embodiment of the present disclosure. During measurement, a load of 1 mN was applied and a Berkovich tip indenter was used.

The hard coating layer 220 is disposed on the glass ceramic substrate 210. The hard coating layer 220 may include a SiO₂-based mixture. In addition, the hard coating layer 220 includes a plurality of Ca agglomerate structures CS. Each of the Ca agglomerate structures CS has a structure in which a plurality of calcium oxide (CaO) or calcium silicate (CaSiO₃) particles are agglomerated and combined together. In FIG. 11B, a table shows constituent elements of the hard coating layer 220 according to an embodiment of the present disclosure and a composition ratio thereof. That is, the hard coating layer 220 according to an embodiment of the present disclosure may include, by wt %, at least 46% but not more than 51% of O, at least 34 but not more than 38% of Si, at least 6% but not more than 7.2% of Al, at least 2% but not more than 5.4% of Ca, and the balance of other impurities.

In the embodiment, the Ca agglomerate structures CS may be formed by a sol-gel process. Specifically, as a Ca-containing mixture is coated on the glass ceramic substrate 210 and a condensation reaction occurs, the plurality of calcium oxide (CaO) or calcium silicate (CaSiO₃) particles agglomerate by a heat treatment process. In this regard, a diameter of each of the calcium (Ca) agglomerate structures CS may be at least 40 nm but not more than 60 nm.

According to the embodiment, the Ca agglomerate structures CS may be distributed at least in an area adjacent to the glass ceramic substrate 210. In a preferred embodiment, a proportion of Ca agglomerate structures CS per unit volume may increase closer to the upper surface of the glass ceramic substrate 210 in a cross-section perpendicular to the upper surface of the glass ceramic substrate 210, i.e., in a cross-sectional view.

Specifically, the hard coating layer 220 includes a first region 221 and a second region 222. The first region 221 may be disposed on the glass ceramic substrate 210. The first region 221 includes calcium distributed in the form of Ca agglomerate structures CS. In the embodiment, the Ca content present in the first region 221 may be at least 65% but not more than 85% of the Ca content present in the entire hard coating layer 220.

The second region 222 may be disposed on the first region 221. The second region 222 includes calcium (Ca) distributed in a non-agglomerated form. That is, the second region 222 does not include the Ca agglomerate structures CS.

In the embodiment, in the cross-section, a ratio of a thickness of the first region 221 to a thickness of the second region 222 may be 7:3. That is, according to the embodiment, in an area from the upper surface of the glass ceramic substrate 210 to 70% of the thickness d1 of the hard coating layer 220, at least 65% but not more than 85% of the Ca content in the entire hard coating layer 220 may be present in the form of Ca agglomerate structures CS.

According to an embodiment of the present disclosure, the Ca agglomerate structure CS enhances the bonding strength between the glass ceramic substrate 210 and the hard coating layer 220. Specifically, the Ca agglomerate structure CS may fix the hard coating layer 220 to the glass ceramic substrate 210 by enhancing the rigidity of an area of the hard coating layer 220 adjacent to the glass ceramic substrate 210. Therefore, according to an embodiment of the present disclosure, scratch resistance of the top plate 200 may be improved by preventing delamination of the hard coating layer 220 from the glass ceramic substrate 210.

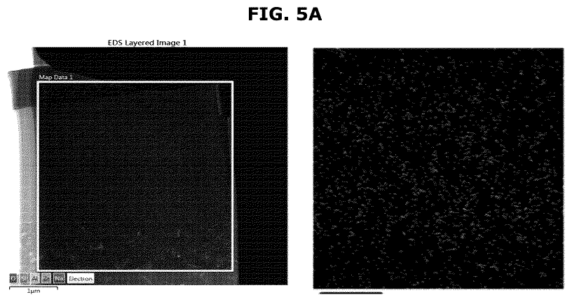

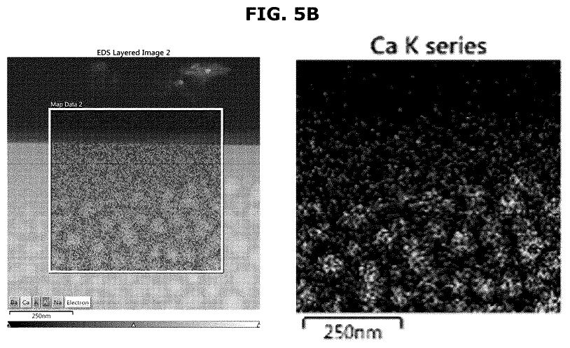

FIG. 5A shows distribution of calcium in area B of a conventional top plate. FIG. 5B shows distribution of calcium in area B of a top plate according to an embodiment of the present disclosure.

Left-side images of FIGS. 5A and 5B are images of area B obtained by transmission electron microscopy (TEM) and energy dispersive X-ray spectroscopy (EDS), respectively. A TEM is used to visualize the internal structure of the hard coating layer by emitting electron beams to pass therethrough, and the EDS is used to analyze a chemical composition of the hard coating layer by emitting electron beams and measuring X-rays emitted from specific elements.

Right-side images of FIGS. 5A and 5B are images of areas where calcium elements are present as a result of mapping by energy dispersive X-ray spectroscopy (EDS).

Referring to FIG. 5A, although calcium is present in the conventional hard coating layer 220, calcium is uniformly distributed over the entire area in a non-agglomerated form. In this case, because the agglomerate structures are not present in the hard coating layer, the hard coating layer does not affect bonding strength between the hard coating layer and the glass ceramic substrate 210. However, referring to FIG. 5B, it may be confirmed that a plurality of agglomerated forms of calcium are present in an area of the hard coating layer 220 adjacent to the glass ceramic substrate 210 according to an embodiment of the present disclosure.

Referring back to FIG. 3, the encapsulation layer 230 is disposed on the hard coating layer 220 to cover the hard coating layer 220. In the embodiment, the encapsulation layer 230 may be an anti-fouling coating layer. That is, the encapsulation layer 230 prevents contaminants such as dust, oil, and water from easily adhering to the surface of the top plate 200 and enables easy cleaning. In the embodiment, the encapsulation layer 230 may have water repellency. For example, the encapsulation layer 230 may include at least one of fluorosilicone, polyfluoroalkylsiloxane, polytetrafluoroethylene (PTFE, Teflon), siloxane, silicone resin, fluoropolymer, and perfluoropolyether. In FIG. 11C, a table shows constituent elements of the encapsulation layer 230 according to an embodiment of the present disclosure and a composition ratio thereof.

In the embodiment, the encapsulation layer 230 may be formed by a sol-gel process.

Although not shown in the drawings, a satin process may be performed on the encapsulation layer 230 before the sol-gel process is performed. The satin process, as a process of providing a texture of the top plate 200, is used to apply particular physical properties (e.g., smoothness, reflectivity, and durability) onto the surface of the top plate 200. Particularly, in the embodiment, even though scratches are caused on the top plate 200 by external factors, the satin process may be performed to reduce visibility of the scratches. The satin process includes a blasting process, an etching process, and a polishing process. The blasting process is a process of roughening a surface of a material by impacting the surface with particles sprayed at a high pressure or a process of removing impurities and an oxide layer. The etching process may be a process of finely removing the surface of a material by a chemical or electrolytic method. The polishing process is a process of smoothing the surface and providing gloss thereto. In another embodiment of the present disclosure, the polishing process may be omitted.

In the embodiment, a surface roughness of the encapsulation layer 230 may be at least 0.3 μm but not more than 1.0 μm. In addition, a thickness d2 of the encapsulation layer 230 (FIG. 3) may be at least 0.05 μm but not more than 0.5 μm. In another embodiment of the present disclosure, the encapsulation layer 230 may be omitted.

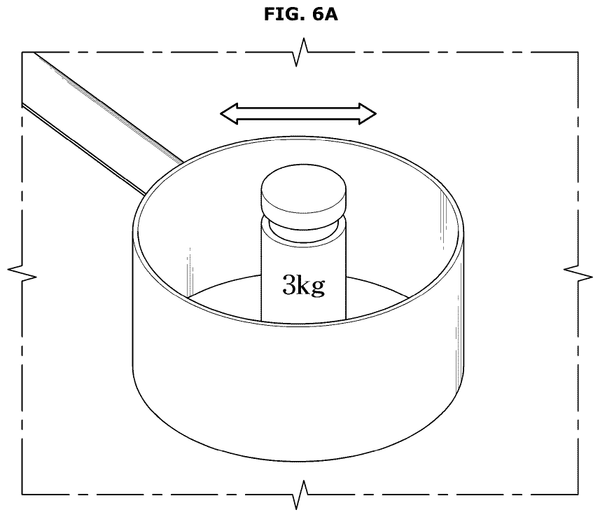

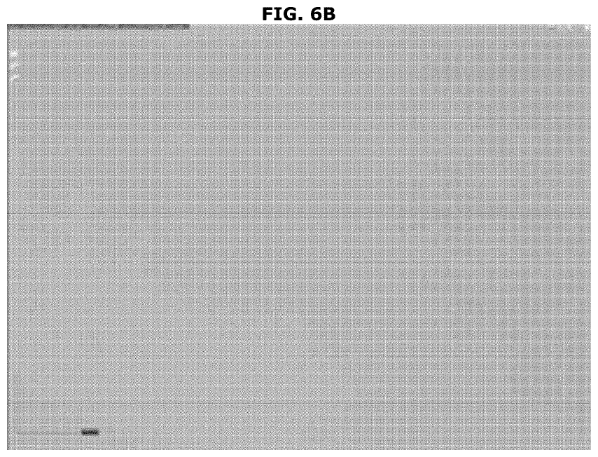

FIG. 6A is a view showing a scratch resistance test of a top plate, and FIG. 6B is a photograph showing the surface of the top plate before the scratch resistance test. In this test, a pot with a load of 3 kg is placed on top of the top plate 200, and reciprocating motion is repeated 100 times on a flat surface. Afterward, the surface of the top plate 200 is cleaned and then photographed.

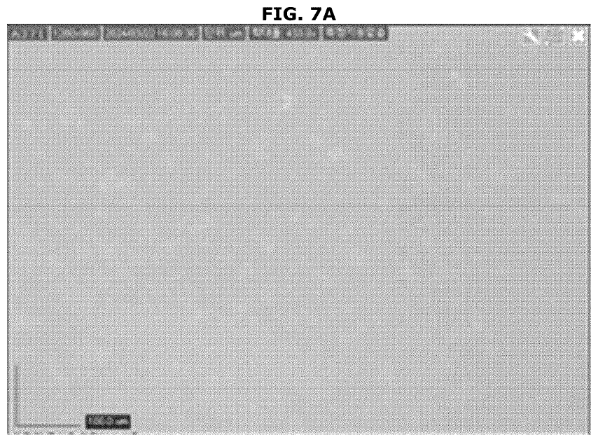

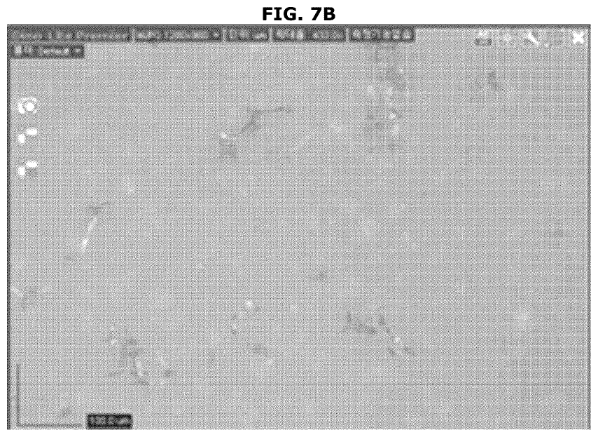

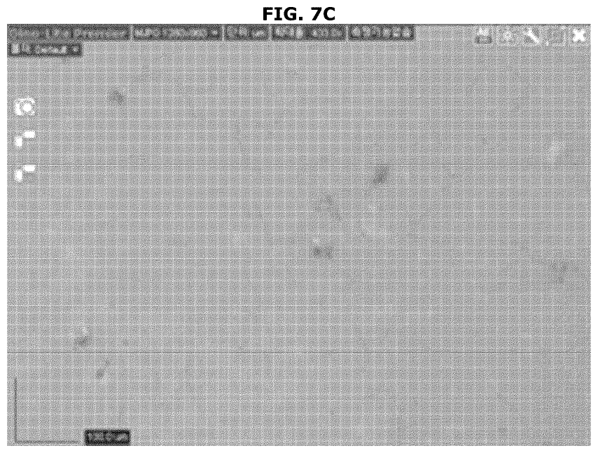

FIG. 7A is a photograph showing an example of the surface of the top plate after completion of the scratch resistance test. FIGS. 7B and 7C are photographs showing comparative examples of the surface of the top plate after completion of the scratch resistance test.

According to an embodiment of the present disclosure, the thickness D of the reinforced stack structure 220 and 230 defined by the hard coating layer 220 and the encapsulation layer 230 may be at least 0.5 μm but not more than 8 μm. Unlike the embodiment of the present disclosure, with a thickness of the reinforced stack structure less than 0.5 μm, scratch resistance may deteriorate. On the other hand, with a thickness of the reinforced stack structure exceeding 8 μm, the reinforced stack structure may be delaminated from the glass ceramic substrate 210.

FIG. 7A is a photograph of the upper surface of the top plate 200 in which a reinforced stack structure 220 and 230 has a thickness of at least 0.5 μm but not more than 8 μm. FIG. 7B is a photograph of the upper surface of a top plate in which a reinforced stack structure has a thickness of less than 0.5 μm. FIG. 7C is a photograph of the upper surface of a top plate in which a reinforced stack structure has a thickness exceeding 8 μm.

As shown in FIG. 7A, in the case where the thickness of the reinforced stack structure 220 and 230 is at least 0.5 μm but not more than 8 μm, traces of the pot were generated on the surface of the top plate but could be removed therefrom. However, as shown in FIG. 7B, in the case where the thickness of the reinforced stack structure is less than 0.5 μm, scratches occurred on the surface of the top plate 200 and traces of coating wear were observed. In addition, as shown in FIG. 7C, in the case where the thickness of the reinforced stack structure exceeds 8 μm, scratches also occurred on the surface of the top plate 200 and coating delamination was observed therein.

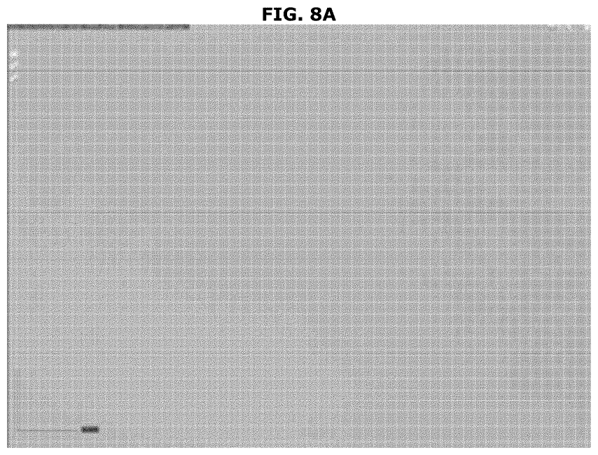

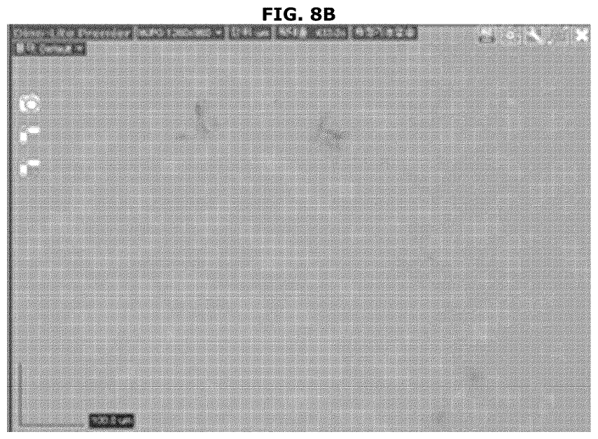

FIG. 8A is a photograph of a surface of a top plate according to an example after completion of a scratch resistance test. FIG. 8B is a photograph of a surface of a top plate according to a comparative example after completion of a scratch resistance test. The tests performed on the top plates of FIGS. 8A and 8B are as shown in FIG. 6A.

As described above, according to an embodiment of the present disclosure, the hard coating layer 220 having superior hardness compared to the glass ceramic substrate 210 has improved bonding strength with the glass ceramic substrate 210 by the Ca agglomerate structures CS, and thus the scratch resistance of the top plate 200 may be enhanced. FIG. 8A is a photograph of the upper surface of the top plate 200 in the case where the hard coating layer 220 includes the Ca agglomerate structures CS. FIG. 8B is a photograph of the upper surface of the top plate that does not include the Ca agglomerate structures.

As shown in FIG. 8A, in the case where the hard coating layer 220 includes the Ca agglomerate structures CS, traces of the pot were generated on the surface of the top plate 200 but were removable. However, as shown in FIG. 8B, in the case where the hard coating layer does not include the Ca agglomerate structures, scratches occurred on the surface of the top plate and the traces were not removable.

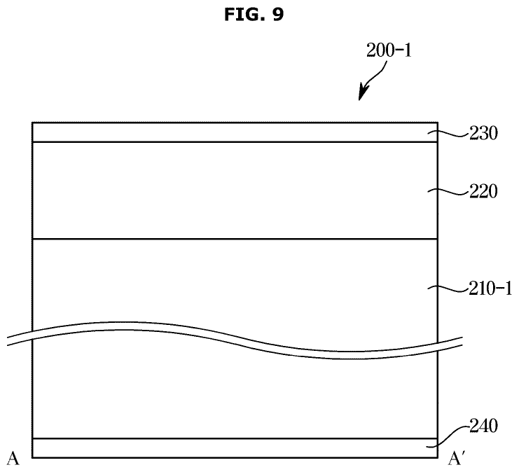

FIG. 9 is a cross-sectional view taken along line A-A′ of a top plate according to another embodiment of the present disclosure.

Referring to FIG. 9, a top plate 200-1 according to another embodiment of the present disclosure may further include a printed layer 240. In the embodiment, the glass ceramic substrate 210 may be colorless and transparent. For example, the glass ceramic substrate 210 may have a beta-quartz crystalline phase.

The printed layer 240 is disposed below the glass ceramic substrate 210-1. The printed layer 240 may have a lower optical transmittance than the glass ceramic substrate 210-1 and the reinforced stack structure 220 and 230. Accordingly, the printed layer 240 may be exposed through the glass ceramic substrate 210-1 and the reinforced stack structure 220, 230. That is, by exposing the printed layer 240, the color of the top plate 200 may be realized.

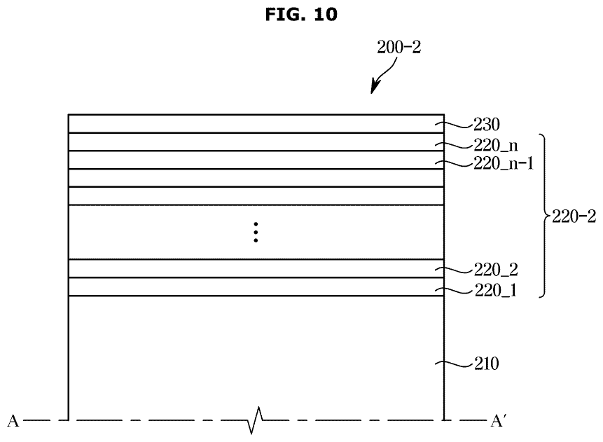

FIG. 10 is a cross-sectional view taken along line A-A′ of a top plate according to another embodiment of the present disclosure.

Referring to FIG. 10, a hard coating layer 220-2 of a top plate 200-2 according to another embodiment of the present disclosure may include a plurality of unit coating layers 220_1 to 220_n, including 220_2, 220_n-1 and so on. The plurality of unit coating layers 220_1 to 220_n are stacked in the vertical direction DR3 to form a stack structure. In the embodiment, at least some of the unit coating layers 220_1 to 220_n may include the Ca agglomerate structures CS. That is, the Ca agglomerate structures CS may be distributed in some of the unit coating layers 220_1 to 220_n adjacent to the glass-ceramic substrate 210.

According to the embodiment, because the hard coating layer 220-2 has a stack structure in which a plurality of layers are stacked, the possibility of delamination may be reduced compared to a hard coating layer 220-2 formed as a single layer. Therefore, scratch resistance of the top plate 200-2 may further be enhanced.

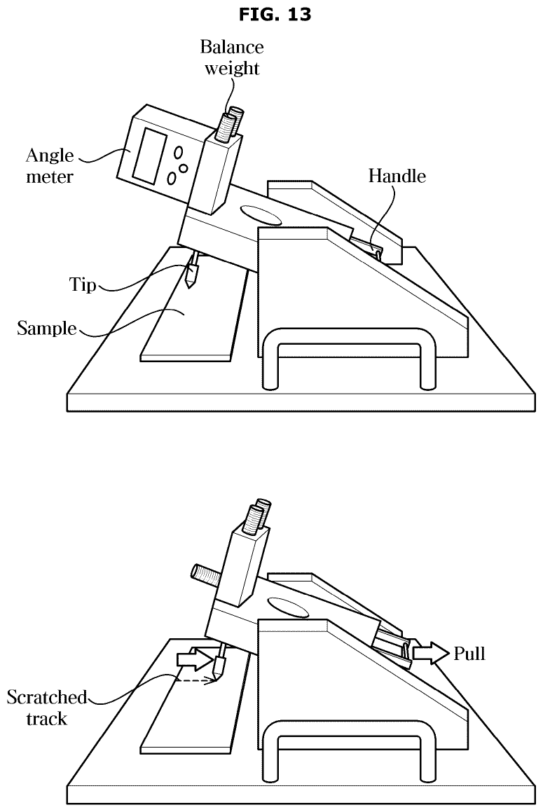

FIG. 13 is a photograph of a Mohs hardness tester for measuring Mohs hardness of the glass-ceramic substrate 210 or the top plate 200 according to an embodiment of the present disclosure.

Referring to FIG. 13, the Mohs hardness is measured by a method described below. First, a sample is placed on the tester, a tip angle is set to 70 degrees, and a 200 g weight is mounted on the tester. Then, a handle is pulled to scratch the fixed sample five times with the tip, followed by cleaning the surface. After visual observation of the cleaned sample to detect occurrence of scratches, a case of observing two or more scratches out of the five scratches is evaluated as occurrence of scratches. On the other hand, in the case where less than three scratches are observed, the tip is replaced and the test is repeated to ultimately measure the Mohs hardness. The plate for cooking apparatuses 200 according to an embodiment of the present disclosure includes a glass ceramic substrate 210 and a hard coating layer 220 disposed on the glass ceramic substrate 210 and including a plurality of Ca agglomerate structures CS in at least some areas. In the hard coating layer 220, in a cross-section perpendicular to the upper surface of the glass ceramic substrate 210, a proportion of Ca agglomerate structures CS per unit volume increases closer to the upper surface of the glass ceramic substrate 210.

The hard coating layer 220 includes the first region on the glass ceramic substrate 210, in contact with the upper surface of the glass ceramic substrate 210, and which containing Ca calcium distributed through the first region in a form of the Ca agglomerate structures, and the second region on the first region and containing calcium distributed through the second region in a non-agglomerated form, and a percentage of the Ca content present in the first region to the Ca content present in the entire hard coating layer is at least 65% but not more than 85%.

A ratio of a thickness of the first region 221 to a thickness of the second region 222 is 7:3.

The hard coating layer 220 includes, by wt %, %, at least 46% but not more than 51% of O, at least 34% but not more than 38% of Si, at least 6% but not more than 7.2% of Al, at least 2% but not more than 5.4% of Ca, and a remaining balance of other impurities.

The glass ceramic substrate 210 includes a lithium aluminosilicate crystalline glass including Li₂O, Al₂O₃, and SiO₂.

A diameter of each of the Ca agglomerate structures CS is at least 40 nm but not more than 60 nm.

A color difference (ΔE) between the hard coating layer 220 and the glass ceramic substrate 210 is at least 0 but not more than 2.

The glass ceramic substrate 210 has an L* value of at least 80 but not more than 100 in the CIE Lab* color space.

According to another embodiment of the present disclosure, the hard coating layer 220 may further include an inorganic pigment.

The plate for cooking apparatuses 200 according to the embodiment further include an encapsulation layer 230 disposed on the hard coating layer 220 to cover the hard coating layer 220, wherein a surface roughness of the encapsulation layer 230 is at least 0.3 but not more than 1.0 μm.

A stack structure of the hard coating layer 220 and the encapsulation layer 230 may have a thickness of at least 0.5 μm but not more than 8 μm. In this regard, the thickness of the encapsulation layer 230 is at least 0.05 μm but not more than 0.5 μm.

The glass ceramic substrate 210, the hard coating layer 220, and the encapsulation layer 230 have a coefficient of thermal expansion of 1×10⁻⁶ K⁻¹ or less in a temperature range of 20° C. to 650° C., respectively.

The encapsulation layer 230 has water repellency.

The plate for cooking apparatuses 200 according to an embodiment of the present disclosure may have a Mohs hardness of at least 6.5 but not more than 7.5.

The plate for cooking apparatuses 200 according to an embodiment of the present disclosure has a nanoindentation hardness of at least 8 GPa but not more than 12 GPa.

The plate for cooking apparatuses 200 further includes the printed layer 240 disposed below the glass ceramic substrate 210 and having a lower optical transmittance than that of the glass ceramic substrate 210 and the hard coating layer 220. As the printed layer 240 is exposed through the glass ceramic substrate 210 and the hard coating layer 220, the color of the plate for cooking apparatuses 200 may be realized.

The hard coating layer 220 has a structure in which a plurality of unit coating layers 220_1 to 220_n are stacked, and the Ca agglomerate structures CS are distributed in some of the unit coating layers 220_1 to 220_n adjacent to the glass-ceramic substrate 210.

The plate for cooking apparatuses 200 according to an embodiment of the present disclosure includes a glass ceramic substrate 210 having a β-spodumene crystalline phase, a hard coating layer 220 disposed on the glass ceramic substrate 210 and including a plurality of Ca agglomerate structures CS distributed in at least an area adjacent to the glass ceramic substrate 210, and an encapsulation layer 230 disposed on the hard coating layer 220 to cover the hard coating layer 220 wherein an L* value in the CIE Lab* color space is at least 80 but not more than 100.

A color difference between the hard coating layer 220 and the glass ceramic substrate 210 and between the encapsulation layer 230 and the glass ceramic substrate 210 is at least 0 but not more than 2, respectively.

The hard coating layer 220 and the encapsulation layer 230 have an optical transmittance of 70% or more, respectively.

A stack structure of the hard coating layer 220 and the encapsulation layer 230 has a thickness of at least 0.5 μm but not more than 8 μm.

The hard coating layer 220 includes, by wt %, at least 46% but not more than 51% of O, at least 34 but not more than 38% of Si, at least 6% but not more than 7.2% of Al, at least 2% but not more than 5.4% of Ca, and the balance of other impurities.

The encapsulation layer 230 has a surface roughness of at least 0.3 but not more than 1.0 μm.

The plate for cooking apparatuses according to an embodiment of the present disclosure has a Mohs hardness of at least 6.5 but not more than 7.5 and a nanoindentation hardness of at least 8 Gpa but not more than 12 GPa.

The cooking apparatus 1000 according to an embodiment of the present disclosure includes a plate for cooking apparatuses 200 on which a cooking container CT is placed and a main body 100 disposed below the plate for cooking apparatuses 200 and including a plurality of induction heating coils 121, 122, and 123 configured to generate a magnetic field, wherein the plate for cooking apparatuses 200 includes a glass ceramic substrate 210, and a colorless transparent hard coating layer 220 disposed on the glass ceramic substrate 210, wherein the hard coating layer 220 includes a plurality of Ca agglomerate structures CS each having a diameter of at least 40 nm but not more than 60 nm.

Unlike the embodiment of the present disclosure, in conventional ceramic glass, the composition ratio of materials constituting a hard coating layer is limited to obtain a certain level or more of mechanical strength, and optical transmittance of the hard coating layer decreases due to the composition ratio. That is, because the conventional hard coating layer is colored rather than transparent, it is difficult to realize cooking apparatuses in various colors. However, according to an embodiment of the present disclosure, a certain level or more of mechanical strength may be obtained due to the Ca agglomerate structures CS of the hard coating layer 220 although the hard coating layer is colorless and transparent, and thus it is possible to provide a plate for cooking apparatuses having various colors. Particularly, in implementation of a white plate for cooking apparatuses, excellent scratch resistance may be obtained even by using a colorless transparent hard coating layer 220.

The effects obtainable by the present disclosure are not limited to the aforementioned effects, and any other effects not mentioned herein will be clearly understood from the following description by those skilled in the art to which the present disclosure pertains.

Although the embodiments of the present disclosure have been provided for illustrative purposes, the scope of the present disclosure is not limited thereto. Various embodiments that may be modified and altered by those skilled in the art without departing from the principles and spirit of the present disclosure, the scope of which is defined in the claims, should be construed as falling within the scope of the present disclosure.

1. A plate for cooking apparatuses comprising:
a glass ceramic substrate; and
a hard coating layer on the glass ceramic substrate, the hard coating layer including a plurality of calcium (Ca) agglomerate structures in at least one area,
wherein in the hard coating layer, in a cross-section perpendicular to an upper surface of the glass ceramic substrate, as the Ca agglomerate structures are closer to the upper surface of the glass ceramic substrate, a ratio of the Ca agglomerate structures per unit volume increases.

2. The plate according to claim 1, wherein the hard coating layer includes:
a first region on the glass ceramic substrate, in contact with the upper surface of the glass ceramic substrate, and including calcium distributed through the first region in a form of the Ca agglomerate structures; and
a second region on the first region and including calcium distributed through the second region in a non-agglomerated form.

3. The plate according to claim 2, wherein calcium content present in the first region is at least 65% but not more than 85% of calcium content present in all of the hard coating layer.

4. The plate according to claim 2, wherein a ratio of a thickness of the first region to a thickness of the second region is 7:3.

5. The plate according to claim 1, wherein the hard coating layer comprises, by wt %,
at least 46% but not more than 51% of O,
at least 34% but not more than 38% of Si,
at least 6% but not more than 7.2% of Al,
at least 2% but not more than 5.4% of Ca, and
a remaining balance of other impurities.

6. The plate according to claim 1, wherein the glass ceramic substrate comprises a lithium aluminosilicate crystalline glass including Li₂O, Al₂O₃, and SiO₂.

7. The plate according to claim 1, wherein a diameter of each of the Ca agglomerate structures is at least 40 nm but not more than 60 nm.

8. The plate according to claim 1, wherein a color difference between the hard coating layer and the glass ceramic substrate is at least 0 but not more than 2.

9. The plate according to claim 1, wherein the glass ceramic substrate has an L* value of at least 80 but not more than 100 in CIE Lab* color space.

10. The plate according to claim 9, wherein the hard coating layer further comprises an inorganic pigment.

11. The plate according to claim 9, further comprising:
an encapsulation layer disposed on the hard coating layer to cover the hard coating layer,
wherein the encapsulation layer has a surface roughness of at least 0.3 μm but not more than 1.0 μm.

12. The plate according to claim 11, wherein a stack structure of the hard coating layer and the encapsulation layer has a thickness of at least 0.5 μm but not more than 8 μm.

13. The plate according to claim 11, wherein the glass ceramic substrate, the hard coating layer, and the encapsulation layer have a coefficient of thermal expansion of 1×10⁻⁶ K⁻¹ or less in a temperature range of 20° C. to 650° C., respectively.

14. The plate according to claim 11, wherein the encapsulation layer has water repellency.

15. The plate according to claim 1, wherein a Mohs hardness is at least 6.5 but not more than 7.5.
